(19) United States
(12) Patent Application Publication
(10) Pub. No.: US 2020/0149253 A1
(43) Pub. Date: May 14, 2020

(54) ROTARY CONTROL STRUCTURE FOR WATER VALVE

(71) Applicant: Greatness Sanitary Industrial Co., Ltd, Xiushui Township (TW)

(72) Inventor: Chiu-Chih Chung, Changhua County (TW)

(21) Appl. No.: 16/188,465

(22) Filed: Nov. 13, 2018

(51) Int. Cl. E03C 1/04; F16K 31/50

(52) U.S. Cl. CPC E03C 1/0404; F16K 31/50

(57) ABSTRACT

A rotary control structure for a water valve contains: a body accommodating a control shaft, a connection disk, a stop sheet, a guide disc, a limitation unit, and an inflow seat. The body includes a receiving space and an outlet. The stop sheet includes a sector cutout. The guide disc includes a fan-shaped aperture corresponding to the sector cutout. The limitation unit is mounted below the guide disc and is configured to limit the connection disk, the stop sheet, and the guide disc in the receiving space. The inflow seat is secured on the body and includes an accommodation groove, an aperture, multiple inlets, a closing cap, and a fitting peg. The control shaft includes an insertion, and the insertion has a concaved hook, wherein the connection disk includes a notch, the notch has a V-shaped retaining portion, and the connection disk includes a rib.

### FIELD OF THE INVENTION

The present invention relates to a rotary control structure for a water valve which is connected easily and quickly.

### BACKGROUND OF THE INVENTION

A conventional water valve is employed to control water supply from a faucet, for example, a control shaft on the water valve is rotated to drive a ceramics sheet to move so that water flows or stops flowing from an outlet of the water valve.

Referring to FIG. 1, the conventional water valve includes a control shaft 2 fixed in a receiving space 13 of a body 1, a stop sheet 4, a guide disc 5, and a limitation unit 6 mounted on a bottom of the body 1. The control shaft 2, the stop sheet 4, the guide disc 5 are adhered by adhesive glue, and the control shaft 2 is inserted into a receiving orifice of the body 1. However, such a connection of the body 1, the control shaft 2, the stop sheet 4, and the guide disc 5 is troublesome. Furthermore, the control shaft 2, the stop sheet 4, and the guide disc 5 are not fixed securely.

The present invention has arisen to mitigate and/or obviate the afore-described disadvantages.

### SUMMARY OF THE INVENTION

The primary aspect of the present invention is to provide a rotary control structure for a water valve which is connected easily and quickly.

To obtain the above aspect, a rotary control structure for a water valve provided the present invention contains: a body accommodating a control shaft, a connection disk, a stop sheet, a guide disc, a limitation unit, and an inflow seat.

The body includes a receiving space, a lower end of the body is in connection with an inflow seat to guide water, and the body further includes an outlet defined on an intermediate section of the body.

The connection disk is connected with the control shaft and a stop sheet to actuate the stop sheet to rotate, the stop sheet includes a sector cutout formed on a bottom of the stop sheet.

The guide disc is fixed below the stop sheet and includes a fan-shaped aperture corresponding to the sector cutout of the stop sheet, wherein when the sector cutout corresponds to and communicates with the fan-shaped aperture, the water flows into the fan-shaped aperture via the sector cutout; and when the sector cutout does not communicate with the fan-shaped aperture, the water stops flowing into the fan-shaped aperture from the sector cutout.

The limitation unit is mounted below the guide disc and is configured to limit the connection disk, the stop sheet, and the guide disc in the receiving space.

The inflow seat is secured on the lower end of the body and includes an accommodation groove defined on a central position of a top of the inflow seat, an aperture formed on a center of the accommodation groove, multiple inlets surrounding the aperture, a closing cap accommodated in the aperture, and a fitting peg extending from a center of the closing cap so as to insert into a top of the aperture of the inflow seat and to abut against the multiple inlets.

The control shaft is pushed downward to connect with the connection disk, the control shaft includes an insertion formed on a bottom of the control shaft, and the insertion has a concaved hook, wherein the connection disk includes a notch corresponding to the insertion, the notch has a V-shaped retaining portion corresponding to the concaved hook, and the connection disk includes a rib extending from a bottom thereof so as to connect with the stop sheet.

### BRIEF DESCRIPTION OF THE DRAWINGS

FIG. 1 is a cross sectional view of a conventional rotary control structure for a water valve.

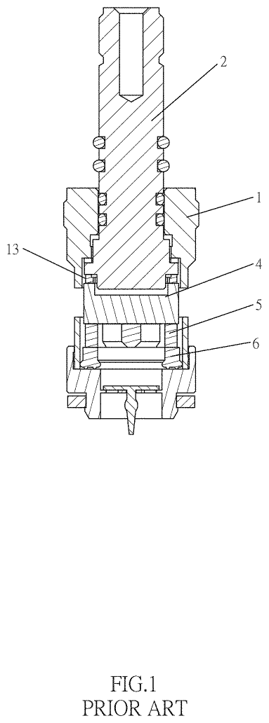

FIG. 2 is a perspective view showing the exploded components of a rotary control structure for a water valve according to a preferred embodiment of the present invention.

FIG. 3 is a perspective view showing the assembly of the rotary control structure for the water valve according to the preferred embodiment of the present invention.

FIG. 4 is a cross sectional view showing the assembly of the rotary control structure for the water valve according to the preferred embodiment of the present invention.

FIG. 5 is a cross-sectional perspective view from the connection disk 3 of FIG. 2 showing the assembly of a part of the rotary control structure for the water valve according to the preferred embodiment of the present invention.

FIG. 6 is a perspective view showing the assembly of a part of the rotary control structure for the water valve according to the preferred embodiment of the present invention.

### DETAILED DESCRIPTION OF THE PREFERRED EMBODIMENTS

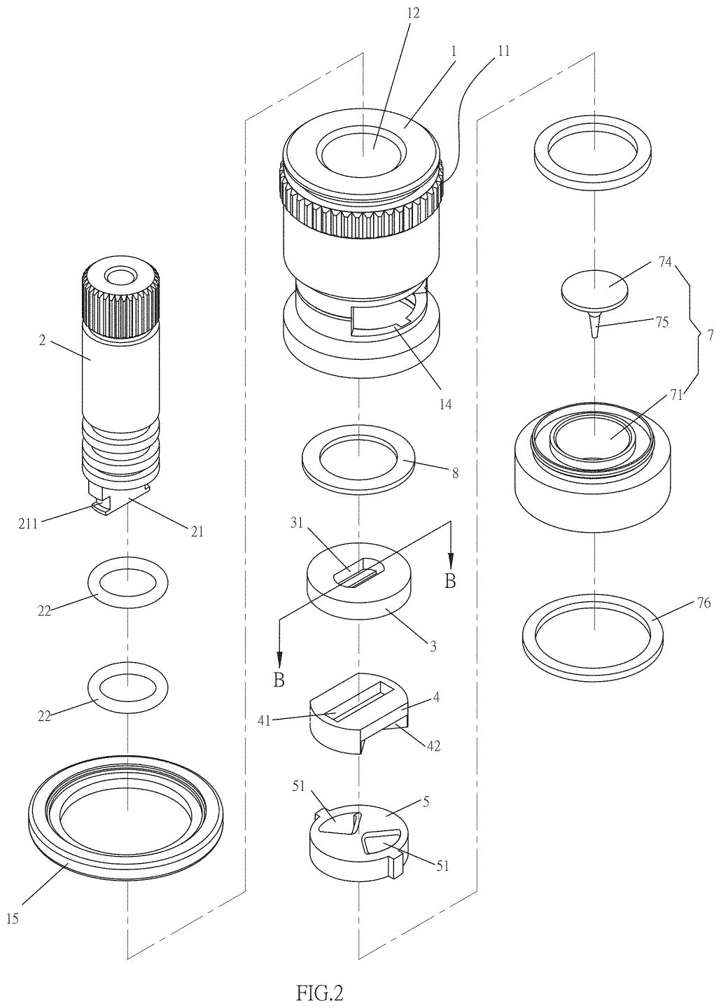

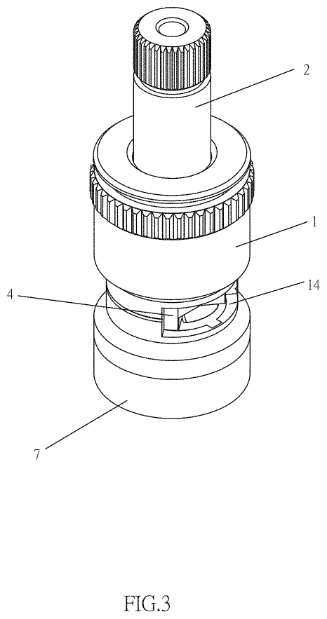

With reference to FIGS. 2 and 3, a rotary control structure for a water valve according to a preferred embodiment of the present invention comprising: a body 1, a control shaft 2, a connection disk 3, a stop sheet 4, a guide disc 5, a limitation unit 6, and an inflow seat 7.

Referring to FIGS. 2-4, the body 1 includes a toothed drive section 11 formed on an upper end of the body 1 and configured to connect with a hand tool so that the toothed drive section 11 is operated by the hand tool to lock the body 1 on a faucet, a through orifice 12 defined on a central portion of the body 1 and configured to accommodate the control shaft 2, a receiving space 13 defined below and being coaxial with the through orifice 12, wherein a diameter of the receiving space 13 is more than the through orifice 12, such that the receiving space 13 accommodates the connection disk 3, the stop sheet 4, the guide disc 5, and the limitation unit 6. The body 1 further includes an outlet 14 defined on an outer wall of an intermediate section of the body 1 so as to guide water into a water outflow end of the faucet, wherein a lower end of the body 1 is in connection with the inflow seat 7. Furthermore, the body 1 includes a washer 15 fitted above the toothed drive section 11 so as to stop a water leakage, when the body 1 is locked with the faucet.

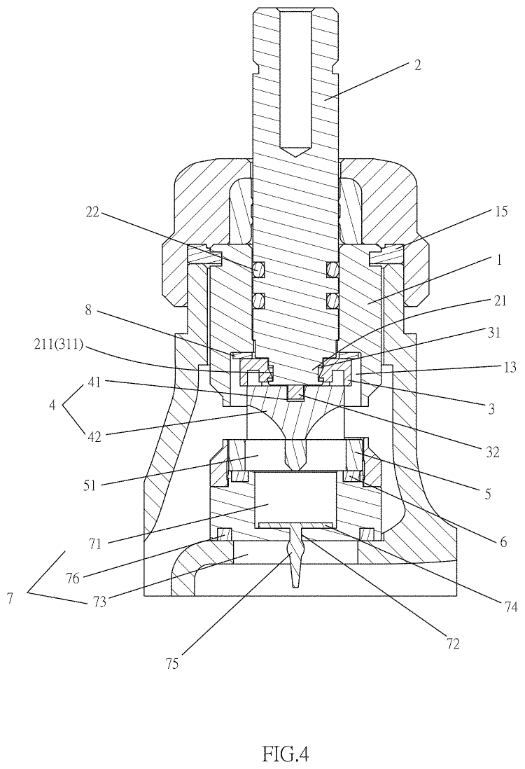

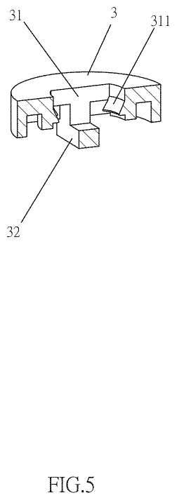

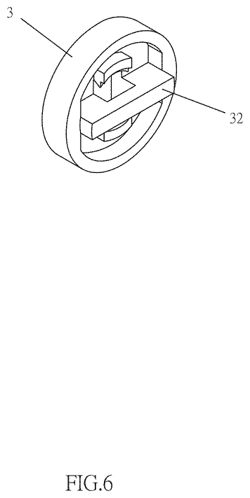

As shown in FIGS. 2-4, a difference of the control shaft 2 from a conventional control shaft comprises: an insertion 23 formed in an H shape on a bottom of the control shaft 2 and inserted into the connection disk 3, wherein the insertion 21 has a concaved hook 211. As illustrated in FIGS. 2 and 4-6, the connection disk 3 includes a notch 31 corresponding to the insertion 21, wherein the notch 31 has a V-shaped retaining portion 311, as shown in FIGS. 4 and 5, when the insertion 21 is inserted into the notch 31, the V-shaped retaining portion 311 matingly engages with the concaved hook 211. The control shaft 2 further includes multiple O-rings 22 fitted thereon so as to stop the water and to matingly contact with the body 1.

With reference to FIGS. 2 and 4-6, the connection disk 3 includes a rib 32 extending from a bottom thereof so as to connect with the stop sheet 4, wherein the notch 31 intersects with the rib 32 in a cross shape so that the rib 32 is driven to force the stop sheet 4 to rotate.

The stop sheet 4 is in connection with the connection disk 3, the stop sheet 4 includes an actuation recess 41 defined on a top thereof and corresponding to the rib 32, and the stop sheet 4 includes a sector cutout 42 formed on a bottom thereof and configured to correspond to a fan-shaped aperture 51 of the guide disc 5, wherein when the sector cutout 42 corresponds to and communicates with the fan-shaped aperture 51, the water flows into the fan-shaped aperture 51 via the sector cutout 42; and when the sector cutout 42 does not communicate with the fan-shaped aperture 51, the water stops flowing into the fan-shaped aperture 51 from the sector cutout 42.

The limitation unit 6 is mounted below the guide disc 5 and is configured to limit the connection disk 3, the stop sheet 4, and the guide disc 5 in the receiving space 13 and to gather the water, thus avoiding the water leakage. Since the stop sheet 4, the guide disc 5, and the limitation unit 6 are well-known art, further remarks are omitted.

The inflow seat 7 is secured on the lower end of the body 1 and is configured to guide the water to flow out of the outlet 14 via the body 1 by mating with the stop sheet 4 and the guide disc 5, wherein the inflow seat 7 includes an accommodation groove 71 defined on a central position of a top of the inflow seat 7, an aperture 72 formed on a center of the accommodation groove 71, multiple inlets 73 surrounding the aperture 72, a closing cap 74 accommodated in the aperture 72, and a fitting peg 75 extending from a center of the closing cap 74 so as to insert into a top of the aperture 72 of the inflow seat 7 and to abut against the multiple inlets 73, thus avoiding the water flowing back to the inflow seat 7. Due to the inflow seat 7 is well-known art, further remarks are omitted. Furthermore, the inflow seat 7 includes a waterproof unit 76 received in a bottom thereof so as to enhance a tightness of the inflow seat 7 and the faucet and to avoid the water leakage.

In assembly, as shown in FIGS. 2 and 4, the connection disk 3, the stop sheet 4, the guide disc 5, and the limitation unit 6 are accommodated in the receiving space 13 of the body 1, the inflow seat 7 is secured on the lower end of the body 1, and the control shaft 2 is pushed downward to the body 1 so that the insertion 21 of the control shaft 2 is inserted into and is retained in the notch 31 of the connection disk 3, thus connecting the rotary control structure for the water valve easily.

Referring to FIGS. 2 and 4, the connection disk 3 includes a wear-resistant ring 8 arranged on a top thereof to abut against a top of the receiving space 13 and to reduce an abrasion of the connection disk 3, thus prolonging a service life of the connection disk 3.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention

What is claimed is:

1. A rotary control structure for a water valve comprising:
a body accommodating a control shaft and including a receiving space, a lower end of the body being in connection with an inflow seat to guide water, and the body further including an outlet defined on an intermediate section of the body;
a connection disk connected with the control shaft and a stop sheet to actuate the stop sheet to rotate, the stop sheet including a sector cutout formed on a bottom of the stop sheet;
a guide disc fixed below the stop sheet and including a fan-shaped aperture corresponding to the sector cutout of the stop sheet, wherein when the sector cutout corresponds to and communicates with the fan-shaped aperture, the water flows into the fan-shaped aperture via the sector cutout; and when the sector cutout does not communicate with the fan-shaped aperture, the water stops flowing into the fan-shaped aperture from the sector cutout;
a limitation unit mounted below the guide disc and configured to limit the connection disk, the stop sheet, and the guide disc in the receiving space;
an inflow seat secured on the lower end of the body and including an accommodation groove defined on a central position of a top of the inflow seat, an aperture formed on a center of the accommodation groove, multiple inlets surrounding the aperture, a closing cap accommodated in the aperture, and a fitting peg extending from a center of the closing cap so as to insert into a top of the aperture of the inflow seat and to abut against the multiple inlets;
wherein the control shaft is pushed downward to connect with the connection disk, the control shaft includes an insertion formed on a bottom of the control shaft, and the insertion has a concaved hook, wherein the connection disk includes a notch corresponding to the insertion, the notch has a V-shaped retaining portion corresponding to the concaved hook, and the connection disk includes a rib extending from a bottom thereof so as to connect with the stop sheet.

2. The rotary control structure as claimed in claim 1, wherein the connection disk includes a wear-resistant ring arranged on a top thereof.

3. The rotary control structure as claimed in claim 1, wherein the stop sheet includes an actuation recess defined on a top thereof and corresponding to the rib.
